(19) United States
(12) Patent Application Publication
(10) Pub. No.: US 2025/0214021 A1
(43) Pub. Date: Jul. 3, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/082,357

(22) Filed: Mar. 18, 2025

Related U.S. Application Data
(63) Continuation of application No. PCT/EP2023/066665, filed on Jun. 20, 2023.

(30) Foreign Application Priority Data
Sep. 20, 2022 (EP) 22196490.1

(51) Int. Cl. B01D 46/64; B01D 39/18; B01D 46/00; B01D 46/24; B01D 46/52; B01D 53/02

(52) U.S. Cl. CPC B01D 46/64; B01D 39/18; B01D 46/0002; B01D 46/0036; B01D 46/2414; B01D 46/521; B01D 53/02; B01D 2253/102; B01D 2257/302; B01D 2257/404; B01D 2257/406; B01D 2265/06; B01D 2271/022; B01D 2271/027

(57) ABSTRACT

A gas filter system including an outer filter element having a first filter medium arranged between a first end cap and a second end cap, and an inner filter element having a second filter medium arranged between a third end cap and a fourth end cap, wherein the first, third and fourth end caps are open, wherein the outer filter element is closed at the second end cap, wherein the first filter medium is arrangeable to surround the second filter medium, such that the outer filter element is sealed against the inner filter element between the second end cap and the fourth end cap.

### CROSS-REFERENCE TO RELATED APPLICATIONS

This application is a continuation application of International Application No. PCT/EP2023/066665 having an international filing date of Jun. 20, 2023, and designating the United States, the international application claiming a priority date of Sep. 20, 2022, based on prior filed European patent Application No. EP 22 196 490.1, the entire contents of the aforesaid international application and the aforesaid European patent application being incorporated herein by reference.

### TECHNICAL FIELD

The present invention refers to a gas filter system including an outer filter element having a first filter medium arranged between a first end cap and a second end cap, and an inner filter element having a second filter medium arranged between a third end cap and a fourth end cap, wherein the first filter medium is arrangeable to surround the second filter medium.

### BACKGROUND

Such a filter system is known from DE 10 2018 215 603 A1 or U.S. Pat. No. 5,415,677 A.

In some applications, it is required to filter a gas flow with two filter elements. Typically, the gas flows through a first filter element and then, the prefiltered gas flows through a second filter element. The filter elements may be arranged in a common housing. This kind of filter system is for instance used to filter combustion air for large combustion engines, such as for trucks, construction vehicles or the like. Another application is the filtration of air for fuel cells.

DE 10 2018 215 603 A1 discloses a gas filter system with a first filter element which surrounds a second filter element. At a first axial end, open end caps of the two filter elements are associated with an outlet for clean air. At a second axial end, the first (outer) filter element has an open end cap and the second (inner) filter element has a closed end cap. The closed end cap of the second (inner) filter element is arranged to close the opening in the end cap of the first (outer) filter element at the second axial end.

The filter described in U.S. Pat. No. 5,415,677 A comprises a primary and a secondary air filter element. At a rear end, the primary air filter element and the secondary air filter element are each closed by an end cap. At a front end, open end caps are provided at the primary and at the secondary filter elements. Annular gaskets are disposed at the open end caps in order to seal the primary and secondary filter element against a canister, in which the filter elements are arranged.

It is an object of the invention to provide a gas filter system with improved sealing between two filter elements, which are adapted for joint use.

This object is achieved by a gas filter system according to the invention and use of filter elements according to the invention. Advantageous embodiments are given in the following description.

### SUMMARY

In accordance with the invention, a gas filter system is provided. The gas filter system includes an outer filter element having a first filter medium arranged between a first end cap and a second end cap, and an inner filter element having a second filter medium arranged between a third end cap and a fourth end cap.

The first, third and fourth end caps are open. The first, third and fourth end caps generally have a central opening.

The inner filter element is closed at the fourth end cap. The fourth end cap may be a monolithic closed end cap. Alternatively, a closing means may be permanently affixed to the inner filter element for sealing of the fourth end cap.

The first filter medium is arrangeable to surround the second filter medium. The filter media may be hollow-cylindrical or conical, for example with a circular or oval cross section. The filter media each surround a longitudinal axis. For example, the filter media may be arranged concentric to the common longitudinal axis. Indications of directions such as radial or axial refer to the longitudinal axis. In principle, the first and third end caps are associated with a first axial end and the second and fourth end caps are associated with a second axial end.

During use of the gas filter system, a gas flow is typically first directed through the first filter medium of the outer filter element and then through the second filter medium of the inner filter element.

According to the invention, when the outer filter element is arranged around the inner filter element for use of the gas filter system, the outer filter element is sealed against the inner filter element between the second end cap and the fourth end cap, for example in the radial direction. By sealing of the second and fourth end caps against each other, an intermediate space between the first filter medium and the second filter medium is sealed at the second end. Therefore, gas to be filtered must flow through the first filter medium and the second filter medium, consecutively.

The fourth end cap of the inner filter element may have a (second) sealing section for sealing abutment against the outer filter element, for example in the radial direction. Alternatively or additionally, the second sealing section may provide axial sealing. The second sealing section may be an integral part of the fourth end cap. The fourth end cap—with the second sealing section—is a monolithic foam part.

In general, sealing sections described within the context of this invention are softer than the counterpart against which they seal. For example, a respective sealing section may be made from polyurethane, for example polyurethane foam. The respective counterpart may be made from rigid plastic.

The second end cap of the outer filter element may be a monolithic closed end cap. The monolithic closed end cap may be made of rigid plastic and may be glued to the first filter medium.

Alternatively, a closing means may be permanently affixed to the outer filter element for sealing of the second end cap. The monolithic closed end cap may be made of rigid plastic.

The outer filter element has a support tube. The support tube stiffens the outer filter element. The support tube may be partially embedded in the first and/or second end cap. The support tube may be made of rigid plastic.

The support tube has a radially inward facing end face, which end face closes the outer filter element at the second end cap. Thus, the support tube is used in a dual function as a stiffening means and as a closing means. By providing the closed end face, manufacturing of the second end cap may be facilitated, as less material is required. For example, the second end cap may be made of polyurethane, for example polyurethane foam, which might be directly molded to the first filter medium and the support tube.

In a mounted state, the fourth end cap may be sealed against the support tube. For example, the second sealing section may sealingly abut the support tube. The support tube may have an annular sealing strip for sealing abutment of the second sealing section. This facilitates sealing of the outer and inner filter elements between the second and fourth end caps. The sealing strip of the support tube has a radially inward facing sealing surface. Radial sealing tolerates slight axial displacement of the inner filter element relative to the outer filter element.

The outer filter element has an axial protrusion at the second end cap, which protrusion protrudes into the inner filter element. The protrusion provides guidance between the filter elements, for example during mounting. The protrusion typically protrudes beyond the fourth end cap of the inner filter element in the axial direction. The protrusion may be formed at the monolithic second end cap or at the end face of the support tube.

The first end cap of the outer filter element may have a first sealing section for sealing abutment against a housing, for example in the axial direction. Alternatively or additionally, the first sealing section may provide radial sealing abutment against the housing.

The third end cap of the inner filter element may have a third sealing section for sealing abutment against a housing, for example in the radial direction. Alternatively or additionally, the third sealing section may provide axial sealing abutment against the housing.

The gas filter system further comprises a housing, in which the inner and outer filter elements are arrangeable. In a mounted state, the filter elements are arranged inside the housing. Typically, the housing comprises a first housing part associated with the first end and a second housing part associated with the second end. An inlet may be formed at the first or second housing part. An outlet is formed at the first housing part. The outlet may be in fluid communication with a clean side inside the inner filter element.

The housing has a dome, which protrudes into the protrusion. The dome may provide guidance during mounting and additional support to the outer filter element during use of the filter system.

The housing may have a central tube, which extends into the inner filter element at the third end cap in a mounted state of the filter system. The central tube provides guidance to the inner filter element and support to the second filter medium.

The central tube may be held at an axial collar of the housing. This is advantageous for manufacturing the filter housing. A snap fit may be provided between the collar and the central tube.

The protrusion and the central tube overlap each other in the axial direction. Mutual guidance and support between the central tube and the outer filter element may be achieved in this way. This may also facilitate mounting of the filter system. For example, the protrusion may engage into the central tube. In other words, the central tube may surround the protrusion radially outwardly.

It may further be provided, that the dome and the central tube overlap each other in the axial direction. Undesired movement of the filter elements during operation may be effectively reduced with this design. Upon heavy vibration, the central tube may bear against the dome via the protrusion, which is arranged between the central tube and the dome.

At least two of an inner wall of the housing, the second end cap, the fourth end cap, the protrusion, the central tube and the dome may have a projection-receiver arrangement which provides for defined installation in a circumferential direction. For example, a radially inward directed projection on the housing wall could project into a recess on the outer circumference of the second end cap.

The first filter medium or the second filter medium, for example the second filter medium of the inner filter element, may have gas-adsorbing properties and may contain activated carbon. Typical harmful gases are SO₂, NOₓ and NH₃.

The first or the second filter medium, for example the first filter medium of the outer filter element, may be made with cellulose.

The first filter medium and/or the second filter medium may be pleated.

The invention also relates to the use of an outer filter element and/or an inner filter element in a gas filter system according to the invention, as described above. The gas filter system may be used for cathode air filtration of a fuel cell in an electric vehicle.

### BRIEF DESCRIPTION OF DRAWINGS

Other advantages and features of the invention will be appreciated from the following description of exemplary embodiments of the invention with reference to the accompanying figures of the drawings, which show significant details. The individual features, as described above or explained below, may each be implemented individually or implemented together in any useful combination in variants of the invention.

FIG. 1 shows a gas filter system according to the invention, the gas filter system comprising an outer filter element, an inner filter element and a housing, in a schematic sectional view.

FIG. 2 shows the outer filter element of the gas filter system of FIG. 1, in a schematic sectional view.

FIG. 3 shows the inner filter element of the gas filter system of FIG. 1, in a schematic sectional view.

FIG. 4 shows a first end of the filter system of FIG. 1 in an enlarged view.

FIG. 5 shows a second end of the filter system of FIG. 1 in an enlarged view.

### DETAILED DESCRIPTION

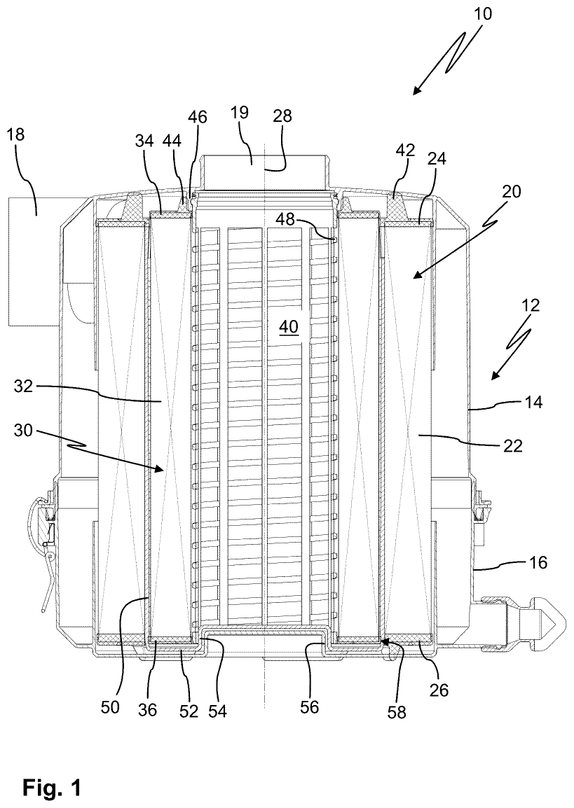

FIG. 1 shows a gas filter system 10. The filter system 10 comprises a housing 12. The housing 12 has a first housing part 14 and a second housing part 16, which are attachable to each other. An inlet 18 allows gas to enter the housing 12. Here the inlet 18 is formed at the first housing part 14. An outlet 19 for filtered gas is also formed at the first housing part 14. The housing parts 14, 16 may be made from metal and/or rigid plastic.

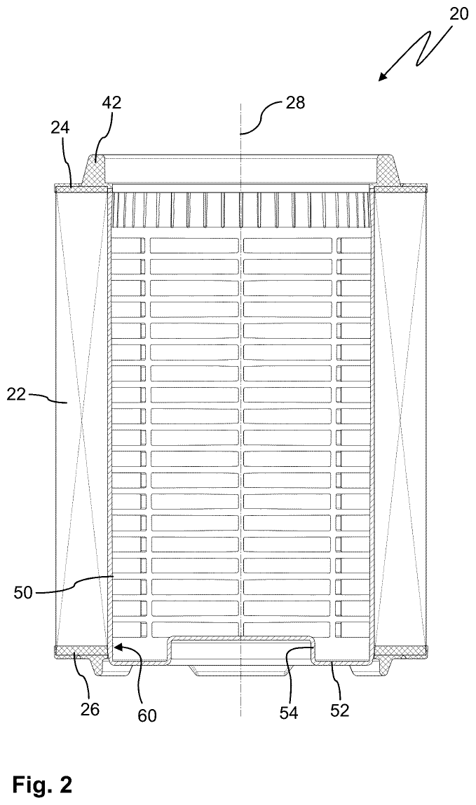

The filter system 10 further comprises an outer filter element 20, see also FIG. 2. The outer filter element 20 comprises a first filter medium 22. The first medium 22 is contained between a first end cap 24 and a second end cap 26. The first filter medium 22 surrounds a longitudinal axis 28 in a circular manner. The first filter medium 22 may be made from pleated cellulose paper.

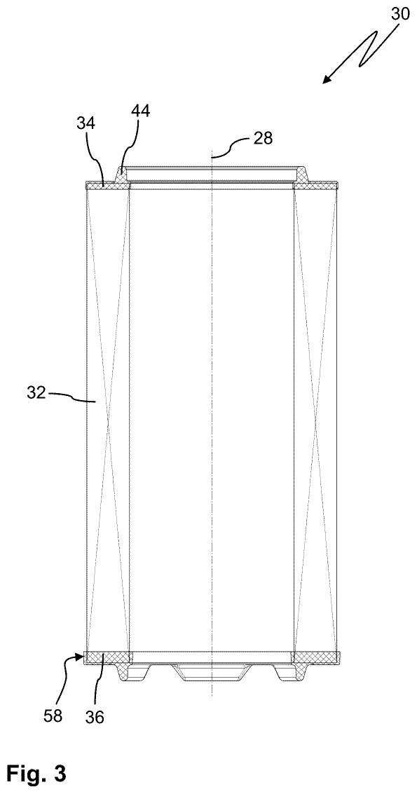

The filter system 10 further comprises an inner filter element 30, see also FIG. 3. The inner filter element 30 comprises a second filter medium 32. The second medium 32 is contained between a third end cap 34 and a fourth end cap 36. The second filter medium 32 also surrounds the longitudinal axis 28 in a circular manner. The second filter medium 32 may contain activated carbon in order to achieve gas-adsorbing properties.

The inner filter element 30 is arranged inside the outer filter element 20. Both filter elements 20, 30 are arranged inside the housing 12. Here, the first filter medium and the second filter medium 22, 32 are concentric to one another and to the longitudinal axis 28.

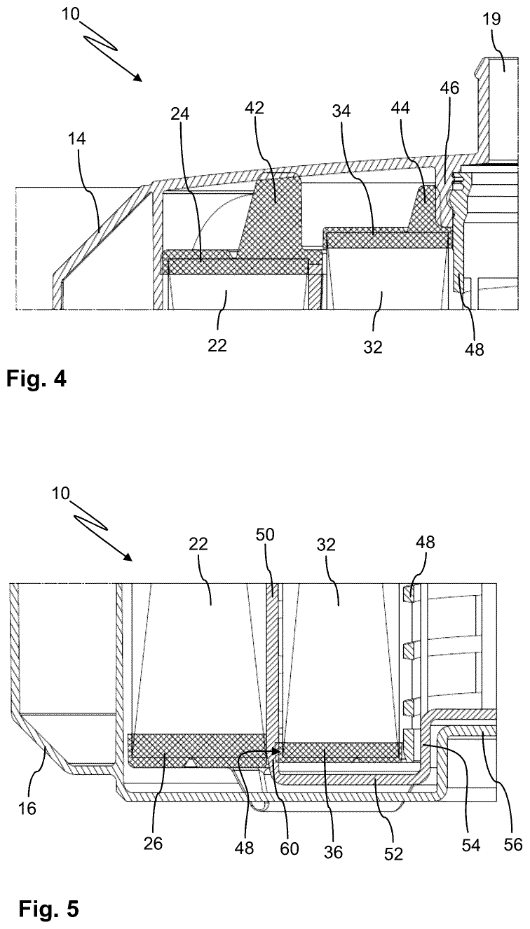

At a first end of the filter system 10, the first end cap 24 is arranged to surround the second filter medium 32 near the third end cap 34, see also FIG. 4. The first end cap 24 and the third end cap 34 each have a central opening, see also FIG. 2 and FIG. 3, respectively. The outlet 19 is in fluid communication with a clean side 40 within the inner filter element 30, cf. FIG. 1.

A first sealing section 42 axially protrudes from the first end cap 24. The first sealing section 42 sealingly abuts the first housing part 14 in the axial direction. Here, the first end cap 24 with the first sealing section 42 is integrally formed from polyurethane foam.

A third sealing section 44 axially protrudes from the third end cap 34. The third sealing section 44 sealingly abuts the first housing part 14 in the radial direction. For example, the third sealing section sealingly 44 rests against a collar 46, which axially protrudes into the housing 12 at the outlet 19. Here, the third end cap 34 and the third sealing section 44 are integrally formed from polyurethane foam.

A central tube 48 of the housing 12 is held at the axial collar 46. The central tube 48 extends through the opening of the third end cap 34 towards the fourth end cap 36. The central tube 48 may be made from rigid plastic.

The outer filter element 20 comprises a support tube 50, see FIG. 1, FIG. 2, FIG. 4 and also FIG. 5. The support tube 50 extends from the first end cap 24 to the second end cap 26 on the inside of the first filter medium 22. The support tube 50 may be made from rigid plastic.

The support tube 50 may be partially embedded in the first end cap and/or second end cap 24, 26. For example, the second end cap 26 is in sealing contact with the support tube 50. Here, the second end cap 26 is made from polyurethane foam and may be molded to the first filter medium 22 and the support tube 50, in order to obtain a permanent connection.

At the second axial end, the support tube 50 has a closed end face 52. The closed end face 52 spans a central area radially inside the first filter medium 22. In this way, the outer filter element 20 is closed at the second end cap 26 by the end face 52 of the support tube 50.

Radially within the second filter medium 32, the closed end face 52 of the support tube 50 forms a protrusion 54, see FIG. 1, FIG. 2 and FIG. 5. The protrusion 54 extends into the inner filter element 30 through a central opening in the fourth end cap 36.

The central tube 48 of the housing 12 and the protrusion 54 of the outer filter element 20 overlap each other along the longitudinal axis 28. The central tube 48 may surround the protrusion 54.

The housing 12 may have a dome 56. Here, the dome 56 is formed at the second housing part 16, which may be a removable cover. The dome 56 extends towards the inside of the inner filter element 30. For example, the dome 56 extends into the protrusion 54 of the outer filter element 20. More particularly, the dome 56, the protrusion 54 and the central tube 48 overlap each other along the longitudinal axis 28.

The fourth end cap 36 is sealed against the outer filter element 20, cf. FIG. 1 and FIG. 5. In the depicted embodiment, a radial sealing is established. The fourth end cap 36, at its outer perimeter, has a second sealing section 58, see also FIG. 3. The fourth end cap 36 with the second sealing section 58 may be integrally formed from polyurethane foam. In other words, the fourth end cap 36 with its sealing section 58 is a monolitic part.

The fourth sealing section 58 sealingly abuts an annular sealing strip 60 (see also FIG. 2) of the support tube 50 in the radial direction. Here, the sealing strip 60 is formed at the same axial height as the second end cap 26. This allows the second end cap 26 and the fourth end cap 36 to seal against the sealing strip 60 from radially outside or inside, respectively.

### REFERENCE NUMBERS

Gas filter system 10
Housing 12
First housing part 14
Second housing part 16
Inlet 18
Outlet 19
Outer filter element 20
First filter medium 22
First end cap 24
Second end cap 26
Longitudinal axis 28
Inner filter element 30
Second filter medium 32
Third end cap 34
Fourth end cap 36
Clean side 40
First sealing section 42
Third sealing section 44
Collar 46
Central tube 48
Support tube 50
End face 52
Protrusion 54
Dome 56
Second sealing section 58
Sealing strip 60

1. A gas filter system comprising
an outer filter element having a first filter medium arranged between a first end cap and a second end cap; and
an inner filter element having a second filter medium arranged between a third end cap and a fourth end cap;
wherein the first, third and fourth end caps are open;
wherein the outer filter element is closed at the second end cap;
the first filter medium being arrangeable to surround the second filter medium, such that the outer filter element is sealed against the inner filter element between the second end cap and the fourth end cap, wherein the outer filter element has an axial protrusion at the second end cap, which protrusion protrudes into the inner filter element.

2. The gas filter system according to claim 5, wherein the fourth end cap has a second sealing section for sealing abutment against the outer filter element.

3. The gas filter system according to claim 1, wherein the second end cap is a monolithic closed end cap.

4. The gas filter system according to claim 1, wherein the outer filter element has a support tube, and wherein the support tube has a radially inward facing end face, which end face closes the outer filter element at the second end cap.

5. The gas filter system according to claim 1, wherein the first end cap of the outer filter element has a first sealing section for sealing abutment against a housing in an axial direction.

6. The gas filter system according to claim 2, wherein the third end cap has a third sealing section for sealing abutment against a housing in a radial direction.

7. The gas filter system according to claim 1 further comprising a housing, in which the inner filter element and the outer filter element are arrangeable.

8. The gas filter system according to claim 7, wherein the housing has a dome that protrudes into the protrusion.

9. The gas filter system according to claim 8, wherein the housing has a central tube that extends into the inner filter element at the third end cap.

10. The gas filter system according to claim 9, wherein the protrusion and the central tube overlap each other in an axial direction.

11. The gas filter system according to claim 9, wherein the dome and the central tube overlap each other in an axial direction.

12. The gas filter system according to claim 1, wherein the first filter medium or the second filter medium has gas-adsorbing properties.

13. The gas filter system according to claim 1, wherein the first filter medium or the second filter medium is made from cellulose.

14. Use of the outer filter element and/or the inner filter element in the gas filter system according to claim 1.
